(19) United States
(12) Patent Application Publication
(10) Pub. No.: US 2008/0144721 A1
(43) Pub. Date: Jun. 19, 2008

(54) VIDEO CODING APPARATUS

(75) Inventors: Shingo SUZUKI, Tokyo (JP); Yoshihiro KIKUCHI, Tokyo (JP); Yuji KAWASHIMA, Tokyo (JP); Tatsuro FUJISAWA, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/831,140

(22) Filed: Jul. 31, 2007

(30) Foreign Application Priority Data
Dec. 19, 2006 (JP) 2006-341235

(51) Int. Cl. H04N 11/02

(52) U.S. Cl. 375/240.24; 375/E07.026

(57) ABSTRACT

According to one embodiment, a video coding apparatus for coding a video signal including a frame which is divided into a plurality of blocks, includes: a prediction section that performs a plurality of predictions for each of the plurality of blocks or each of subblocks into which each of the blocks is divided to output a plurality of prediction signals; a selection section that selects one of the plurality of prediction signals for each of blocks for which the plurality of prediction are performed; a post-processing section that performs a post-processing for the selected one of the plurality of prediction signals; and a controller that controls the post-processing section to change the post-processing based on information regarding a prediction by which the selected one of the plurality of prediction signals is obtained.

### CROSS-REFERENCE TO RELATED APPLICATIONS

This application is based upon and claims the benefit of priority from Japanese Patent Application No. 2006-341235, filed Dec. 19, 2006, the entire contents of which are incorporated herein by reference.

### BACKGROUND

1. Field

One embodiment of the invention relates to a video coding apparatus that codes a video.

2. Description of the Related Art

It is known that an image signal has a statistical nature, namely, there is correlation between pixels in a frame and between pixels in plural frames, and highly efficient coding is performed using the statistical nature. The basic method of band compression coding of a video includes a prediction coding method and a transform coding method. The prediction coding method uses correlation in a time domain. In contrast, the transform coding method uses correlation in a frequency domain.

The prediction coding method includes performing motion compensation prediction (which will be hereinafter referred to as interprediction) from an already coded image frame (which will be hereinafter referred to as a reference frame) to generate a prediction image and coding a differential signal between the image to be coded and the prediction image. On the other hand, the transform coding method includes transforming the image to be coded, divided into blocks for each pixel into a frequency domain by Discrete Cosine Transform (DCT) and quantizing and transmitting an obtained coefficient (which will be hereinafter referred to as DCT coefficient). In recent years, a method using both the methods in combination generally has been adopted.

For example, coding is performed in units of 16×16 pixel block (which will be hereinafter referred to as macro blocks) in International Telecommunication Union-Telecommunication Standardization Sector (ITU-T) recommendations of H.261 and H.263 and Moving Picture Experts Group (MPEG) of standardization work group of image compression organized under International Organization For Standardization (ISO), for example. Recently, H.264 has been standardized for achieving higher data compression. H.264 is a coding method capable of performing highly efficient video coding by using various coding modes.

Such video coding involves an extremely enormous processing amount and causes an increase in apparatus power consumption and an increase in cost. Particularly, if all DCT coefficients are quantized in processing of DCT and quantization, the processing is redundant. Thus, various techniques for decreasing the processing amount are designed.

For example, Japanese Patent Application Publication No. 10-210480 discloses a technique: When an image signal is divided into blocks for coding, the evaluation amount of a prediction residual signal is found for each block. If the evaluation amount is equal to or greater than a threshold value, the block is determined an effective block; when the evaluation amount is less than the threshold value, the block is determined an ineffective block. For the block determined an ineffective block, prediction error information is not sent.

The technique disclosed in the publication makes it possible to skip the processing of DCT and quantization if the coefficients resulting from performing quantization processing become all zero.

Since H.264 involves a large number of coding modes, the processing amount becomes enormous and an increase in apparatus power consumption and an increase in cost may be incurred as described above. The nature of a prediction error signal may change depending on the selected coding mode. Thus, if a fixed processing amount reduction technique is applied regardless of the coding mode as in the publication, it leads to degradation of the image quality and is not preferable from the viewpoint of processing amount reduction.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary drawing to show a configuration to code a video;

FIG. 2 is an exemplary drawing to show a configuration to skip DCT and quantization processing;

FIG. 3 is an exemplary flowchart to show processing for executing interprediction (in DCT processing units of 4×4 pixels) according to a first example of the present invention;

FIG. 4 is an exemplary flowchart to show processing for executing interprediction (in DCT processing units of 8×8 pixels) according to a second example of the present invention;

FIG. 5 is an exemplary flowchart to show processing for executing intra 4×4 prediction according to a third example of the present invention;

FIG. 6 is an exemplary flowchart to show processing for executing intra 8×8 prediction according to a fourth example of the present invention;

FIG. 7 is an exemplary flowchart to show processing for executing intra 16×16 prediction according to a fifth example of the present invention; and

FIG. 8 is an exemplary flowchart to show coding processing for a color difference signal in a sixth example of the present invention.

### DETAILED DESCRIPTION

Various embodiments according to the invention will be described hereinafter with reference to the accompanying drawings. In general, according to one embodiment of the present invention, a video coding apparatus for coding a video signal including a frame which is divided into a plurality of blocks, includes: a prediction section that performs a plurality of predictions for each of the plurality of blocks or each of subblocks into which each of the blocks is divided to output a plurality of prediction signals; a selection section that selects one of the plurality of prediction signals for each of blocks for which the plurality of prediction are performed; a post-processing section that performs a post-processing for the selected one of the plurality of prediction signals; and a controller that controls the post-processing section to change the post-processing based on information regarding a prediction by which the selected one of the plurality of prediction signals is obtained.

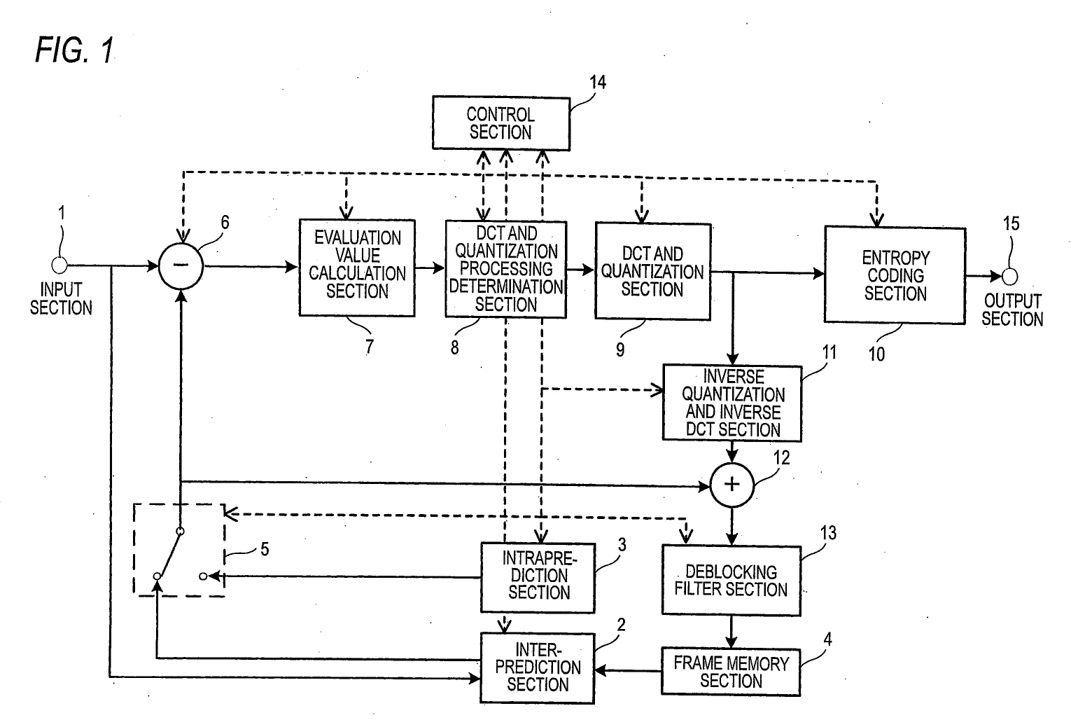

FIG. 1 shows the configuration of a video coding apparatus according to an embodiment of the invention. The video coding apparatus shown in FIG. 1 includes an input section 1, an interprediction section 2, an intraprediction section 3, a frame memory section 4, a selection circuit 5, a subtracter 6, an evaluation value calculation section 7, a DCT/quantization skip determination section 8, a DCT/quantization section 9, an entropy coding section 10, an inverse quantization/inverse DCT section 11, an adder 12, a deblocking filter section 13, a control section 14, and an output section 15.

The input section 1 divides an input image frame signal into blocks and outputs the blocks.

The interprediction section 2 predicts the blocks to be coded included in the image frame signal output from the input section 1 based on the restored past image frame signals stored in the frame memory section 4, calculates an interprediction evaluation value indicating the compression efficiency in interprediction, and outputs a partial image frame signal cut out from the image frame signal stored in the frame memory section 4 as an interprediction signal.

The intraprediction section 3 predicts the blocks to be coded included in the image frame signal output from the input section 1 based on the already coded adjacent block and outputs an intraprediction signal and an intraprediction evaluation value indicating the compression efficiency in intraprediction.

The interprediction evaluation value output from the interprediction section 2 and the intraprediction evaluation value output from the intraprediction section 3 is inputted to the selection circuit 5. The selection circuit 5 switches between a mode of performing interprediction and a mode of performing intraprediction for the blocks included in the image frame signal of the input signal in accordance with measurements of the evaluation values, and stores the selection result in the control section 14.

The subtracter 6 performs operation of calculating the difference between the prediction signal output from the selection circuit 5 and the image frame signal input through the input section 1. The calculated difference is output to the subsequent processing as a differential signal.

The evaluation value calculation section 7 divides the differential signal output from the subtracter 6 into blocks and calculates the Sum of Absolute Difference (SAD) value representing the magnitude of a prediction error signal for each of the blocks.

The DCT/quantization skip determination section 8 outputs a switch signal indicating whether or not DCT/quantization processing is to be skipped in accordance with the SAD value output from the evaluation value calculation section 7 and the coding mode information stored in the control section 14.

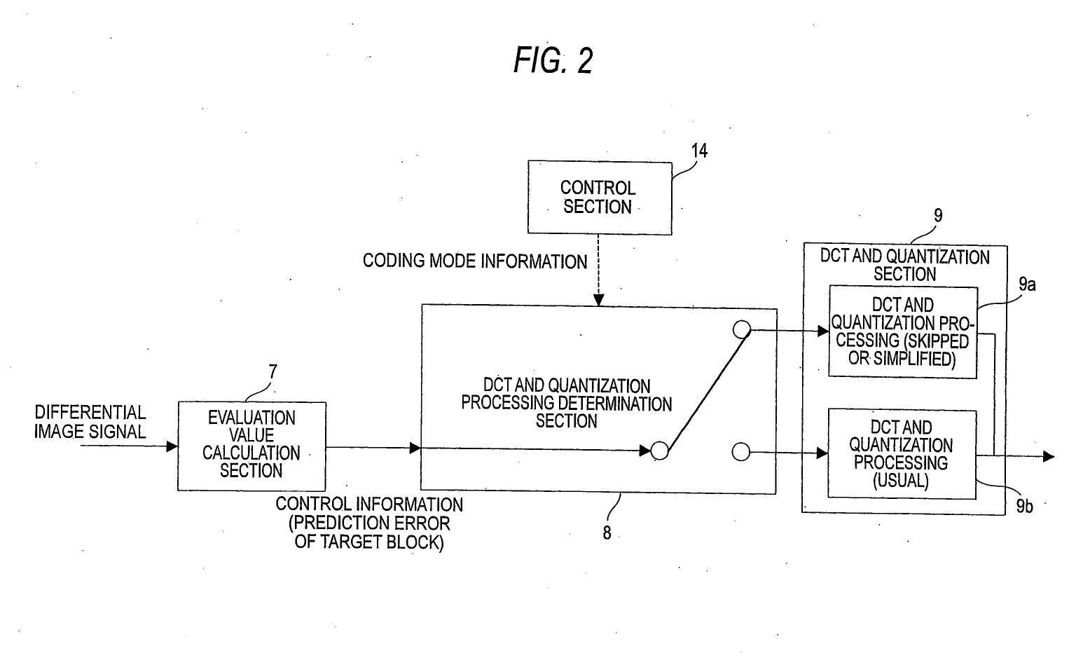

The DCT/quantization section 9 performs DCT and quantization processing according to the switch signal output from the DCT/quantization skip determination section 8 and outputs a DCT coefficient. At this time, the DCT/quantization section 9 switches between usual DCT and quantization processing 9a, and simplified or skipped DCT and quantization processing 9b. FIG. 2 shows an exemplary processing outline of the evaluation value calculation section 7, the DCT/quantization skip determination section 8, and the DCT/quantization section 9. The detailed processing is described later.

The entropy coding section 10 performs entropy coding processing for the DCT coefficient output from the DCT/quantization section 9. For example, a Context-based Adaptive Variable Length Coding (CAVLC) or a Context-based Adaptive Binary Arithmetic Coding (CABAC) is used as the entropy coding.

The output section 15 outputs an entropy-coded signal as a bit stream.

On the other hand, the DCT coefficient output from the DCT/quantization section 9 is also input to the inverse quantization/inverse DCT section 11. The inverse quantization/inverse DCT section 11 performs inverse quantization processing for the inputted DCT coefficient to restore the DCT coefficient and also performs inverse DCT processing for the DCT coefficient to restore the differential signal.

The adder 12 restores the coded image frame signal using the restored differential signal output from the inverse quantization/inverse DCT section 11 and the prediction signal output from the selection circuit 5. The restored image frame signal is stored in the frame memory section 4 through the deblocking filter section 13 and is used for the later interprediction.

The deblocking filter section 13 performs filtering processing for the restored image frame signal output from the adder 12 as processing of decreasing distortion occurring between the blocks as the coding processing units.

H.264/AVC intracoding involves four coding modes in total. That is, three prediction modes of 4×4 intraprediction coding in 4×4 pixel unit for a luminance signal, 8×8 intraprediction coding in 8×8 pixel unit, and 16×16 intrprediction coding in 16×16 pixel unit, and intraprediction coding for a color difference signal. Consequently, if interprediction coding is added, H.264/AVC involves five types of coding processing (coding modes) in total.

In the following examples, discrete cosine transform and quantization processing is adaptively controlled according to each coding mode, whereby the processing load is decreased while degradation of the image quality is suppressed.

The discrete cosine transform and the quantization processing according to the switch signal will be described below.

### FIRST EXAMPLE

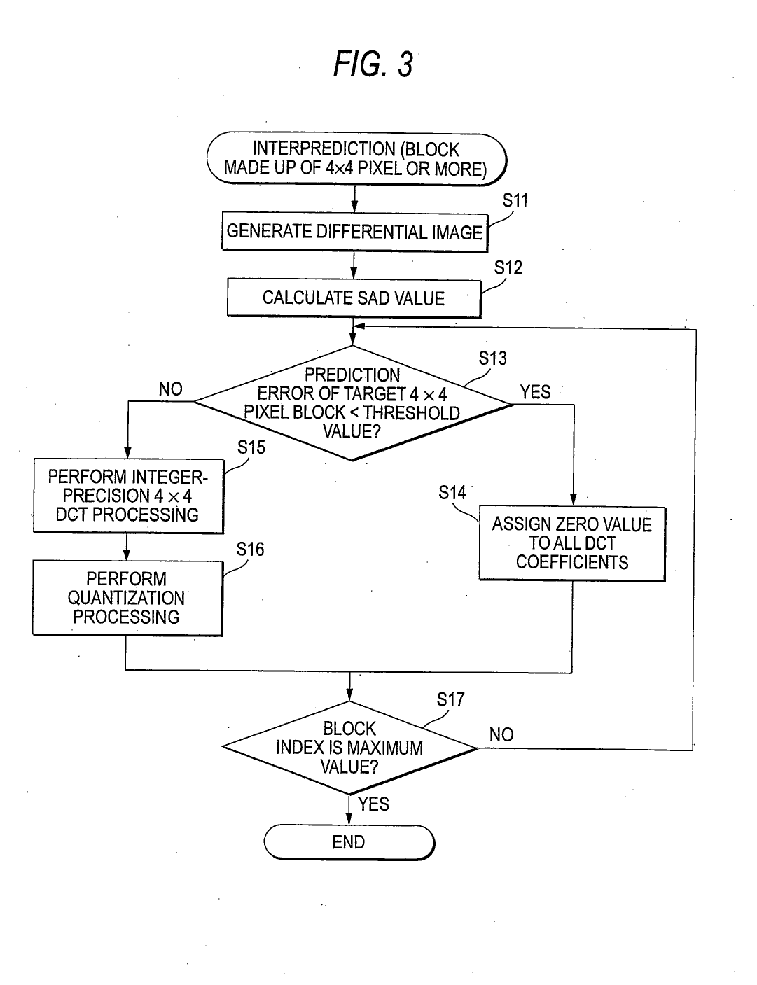

The case where the selection circuit 5 selects the interprediction mode will be described with reference to FIG. 3.

When it is recognized that the prediction mode is the interprediction mode in which a prediction block is 4×4 pixel or more and the DCT processing unit is 4×4 pixel, the subtracter 6 receives the interprediction signal output from the interprediction section 2 through the selection circuit 5 and the signal provided by dividing an input signal and calculates a difference between the signals to generate a differential image under the control of the control section 14 (S11). When the differential image is generated, the control section 14 calculates the Sum of Absolute Difference (SAD) value representing a prediction error for each block made up of 4×4 pixels from the differential image (S12). Here, the 4×4 pixel blocks into which the differential signal is divided are given numbers (0, 1, 2, . . . , N) called block index.

Subsequently, the control section 14 reads a predetermined threshold value according to the coding mode and makes a comparison between the threshold value and the SAD value calculated in 4×4 pixel units, namely, the prediction error to determine whether or not the prediction error is equal to or less than the threshold value (S13).

If the prediction error is equal to or less than the threshold value as a result of the determination, the control section 14 controls the DCT/quantization section 9 so as to assign a zero value to all DCT coefficients (S14).

On the other hand, if it is determined at S13 that the prediction error exceeds the threshold value, the control section 14 controls the DCT/quantization section 9 so as to execute integer-precision DCT processing in block units of 4×4 pixel (S15) and to execute quantization processing for the coefficient obtained in the integer-precision DCT processing (S16).

Upon completion of the DCT and quantization processing, the control section 14 checks whether or not the block index of the block subjected to the processing indicates the maximum value (S17). If the block index indicates the maximum value, the control section 14 terminates the coding processing by the interprediction.

On the other hand, if the block index is not the maximum value, the process returns to S13 and the step of comparison between the prediction error of the next 4×4 pixel block and the threshold value and the later steps are executed.

Upon completion of the processing, the DCT coefficient output from the DCT/quantization section 9 is subjected to variable length coding processing in the entropy coding section 10 and is output.

As described above, the DCT and quantization processing is changed according to the nature of the signal of the coding mode, etc., whereby it is made possible to reduce the processing amount in the DCT and quantization processing while suppressing degradation of the image quality.

### SECOND EXAMPLE

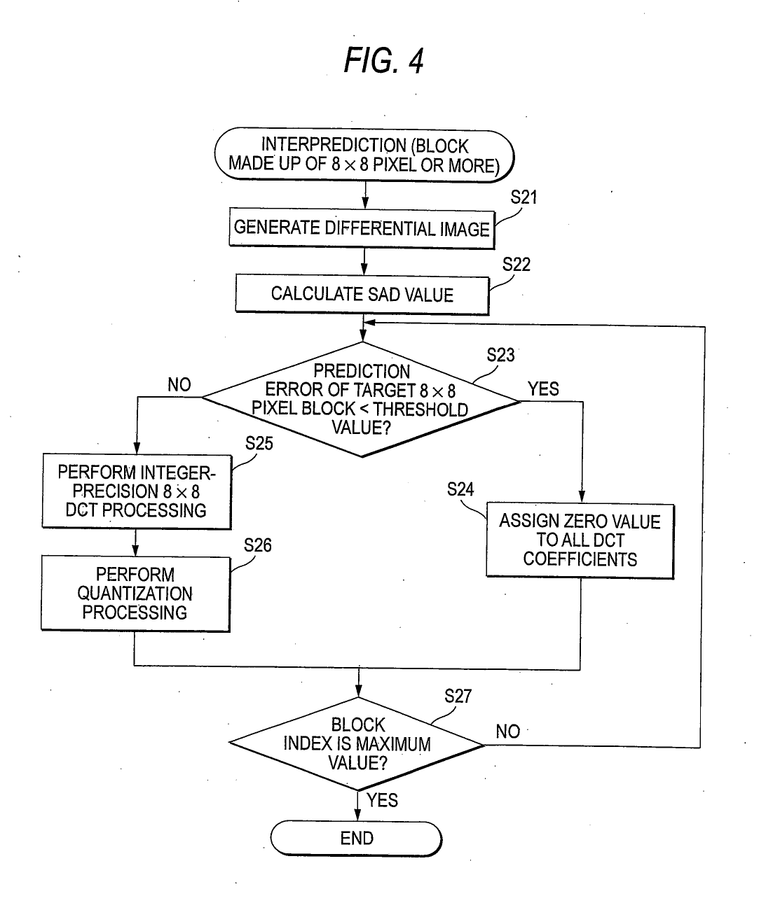

The case where the control section 14 recognizes that the prediction mode is the interprediction mode in which a prediction block is 8×8 or more and the DCT processing unit is 8×8 pixel will be described with reference to FIG. 4.

If it is recognized that the prediction mode is the interprediction mode and the DCT processing unit is 8×8 pixel, the subtracter 6 receives the interprediction signal output from the interprediction section 2 through the selection circuit 5 and the signal provided by dividing an input signal and calculates a difference between the signals to generate a differential image under the control of the control section 14 (S21). When the differential image is generated, the control section 14 calculates a SAD value representing a prediction error for each block made up of 8×8 pixel from the differential image (S22).

Subsequently, the control section 14 reads a predetermined threshold value according to the coding mode and makes a comparison between the threshold value and the SAD value calculated in 8×8 pixel unit, namely, the prediction error to determine whether or not the prediction error is equal to or less than the threshold value (S23).

If the prediction error is equal to or less than the threshold value as a result of the determination, the control section 14 controls the DCT/quantization section 9 so as to assign a zero value to all DCT coefficients (S24).

On the other hand, if it is determined at S23 that the prediction error exceeds the threshold value, the control section 14 controls the DCT/quantization section 9 so as to execute integer-precision DCT processing in block units of 8×8 pixel (S25) and to execute quantization processing for the coefficient obtained in the integer precision DCT processing (S26).

Upon completion of the DCT and quantization processing, the control section 14 checks whether or not the block index of the block subjected to the processing indicates the maximum value (S27). If the block index indicates the maximum value, the control section 14 terminates the coding processing by the interprediction.

On the other hand, if the block index is not the maximum value, the process returns to S23 and the step of comparison between the prediction error of the next 8×8 pixel block and the threshold value and the later steps are executed.

Upon completion of the processing, the DCT coefficient output from the DCT/quantization section 9 is subjected to variable length coding processing in the entropy coding section 10 and is output.

As described above, the DCT and quantization processing is changed according to the nature of the signal of the coding mode, etc., whereby it is made possible to reduce the processing amount in the DCT and quantization processing while suppressing degradation of the image quality.

### THIRD EXAMPLE

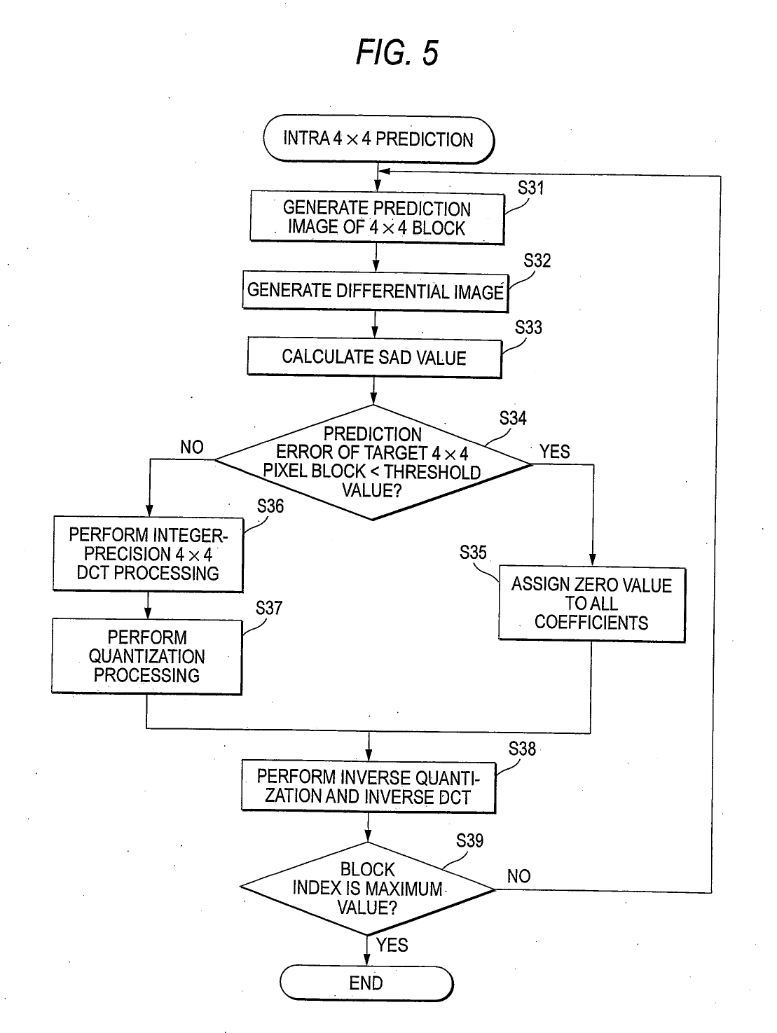

The case where the control section 14 recognizes that the prediction mode is the intra 4×4 prediction mode will be described with reference to FIG. 5.

If it is recognized that the prediction mode is the intra 4×4 prediction mode, a prediction image of a block made up of 4×4 pixel is generated under the control of the control section 14 (S31). The prediction image is generated by predicting pixels in the block to be coded using pixels in the block adjacent to that block.

When the generation of the prediction image terminates, the subtracter 6 generates a differential image in 4×4 pixel unit from the block to be coded, included in an input signal and the prediction image (S32). When the differential image is generated, the control section 14 calculates the SAD value representing a prediction error of the block made up of 4×4 pixel from the differential image (S33).

Subsequently, the control section 14 reads a predetermined threshold value according to the coding mode and makes a comparison between the threshold value and the SAD value calculated in 4×4 pixel units, namely, the prediction error to determine whether or not the prediction error is equal to or less than the threshold value (S34). If the prediction error is equal to or less than the threshold value as a result of the determination, the control section 14 controls the DCT/quantization section 9 so as to assign a zero value to all DCT coefficients (S35).

On the other hand, if it is determined at S34 that the prediction error exceeds the threshold value, the control section 14 controls the DCT/quantization section 9 so as to execute integer precision DCT processing in block units of 4×4 pixel (S36) and to execute quantization processing for the coefficient obtained in the integer precision DCT processing (S37).

Inverse quantization and inverse DCT are performed for the DCT coefficient obtained at step S37 to restore the prediction signal (S38).

Upon completion of the processing up to S38, the control section 14 checks whether or not the block index of the block subjected to the processing indicates the maximum value (S39). If the block index indicates the maximum value, the control section 14 terminates the coding processing by the intra 4×4 prediction.

On the other hand, if the block index is not the maximum value, the process returns to S31 and processing for the next 4×4 pixel block is continued.

Upon completion of the processing, the DCT coefficient output from the DCT/quantization section 9 is subjected to variable length coding processing in the entropy coding section 10 and is output.

As described above, the DCT and quantization processing is changed in response to the nature of the signal of the coding mode, etc., whereby it is made possible to reduce the processing amount in the DCT and quantization processing while suppressing degradation of the image quality.

### FOURTH EXAMPLE

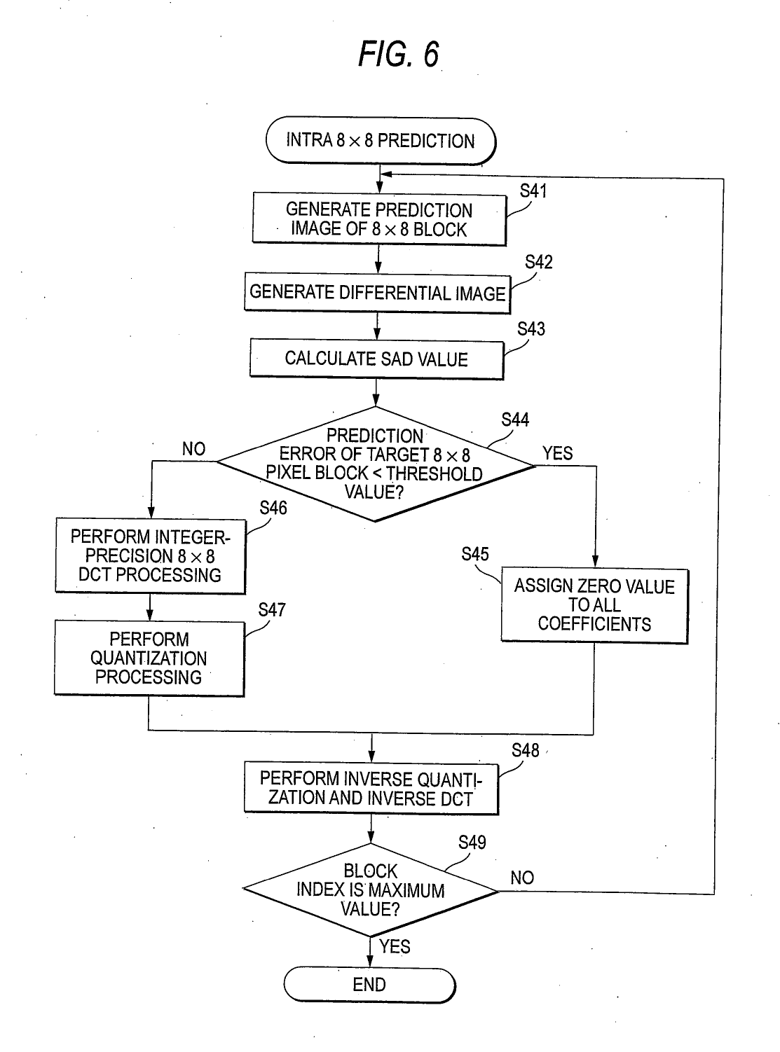

The case where the control section 14 recognizes that the prediction mode is the intra 8×8 prediction mode will be described with reference to FIG. 6.

If it is recognized that the prediction mode is the intra 8×8 prediction mode, a prediction image in 8×8 pixel units is generated under the control of the control section 14 (S41). The prediction image is generated by predicting pixels in the block to be coded using pixels in the block adjacent to that block.

When the generation of the prediction image of the 8×8 pixel block terminates, the subtracter 6 generates a differential image in 8×8 pixel units from the block to be coded, included in an input signal and the prediction image (S42). When the differential image is generated, the control section 14 calculates the SAD value representing a prediction error of the block made up of 8×8 pixels from the differential image (S43).

Subsequently, the control section 14 reads a predetermined threshold value according to the coding mode and makes a comparison between the threshold value and the SAD value calculated in 8×8 pixel units, namely, the prediction error to determine whether or not the prediction error is equal to or less than the threshold value (S44). If the prediction error is equal to or less than the threshold value as a result of the determination, the control section 14 controls the DCT/quantization section 9 so as to assign a zero value to all DCT coefficients (S45).

On the other hand, if it is determined at S44 that the prediction error exceeds the threshold value, the control section 14 controls the DCT/quantization section 9 so as to execute integer precision DCT processing in block units of 8×8 pixel (S46) and to execute quantization processing for the coefficient obtained in the integer precision DCT processing (S47).

Then, inverse quantization and inverse DCT are performed for the DCT coefficient obtained at step S47 to restore the prediction signal (S48).

Upon completion of the processing up to S48, the control section 14 checks whether or not the block index of the block subjected to the processing indicates the maximum value (S49). If the block index indicates the maximum value, the control section 14 terminates the coding processing based on the intra 8×8 prediction.

On the other hand, if the block index is not the maximum value, the process returns to S41 and processing for the next 8×8 pixel block is continued.

Upon completion of the processing, the DCT coefficient output from the DCT/quantization section 9 is subjected to variable-length coding processing in the entropy coding section 10 and is output.

Thus, the DCT and quantization processing is changed according to the nature of the signal of the coding mode, etc., whereby it is made possible to reduce the processing amount in the DCT and quantization processing while suppressing degradation of the image quality.

### FIFTH EXAMPLE

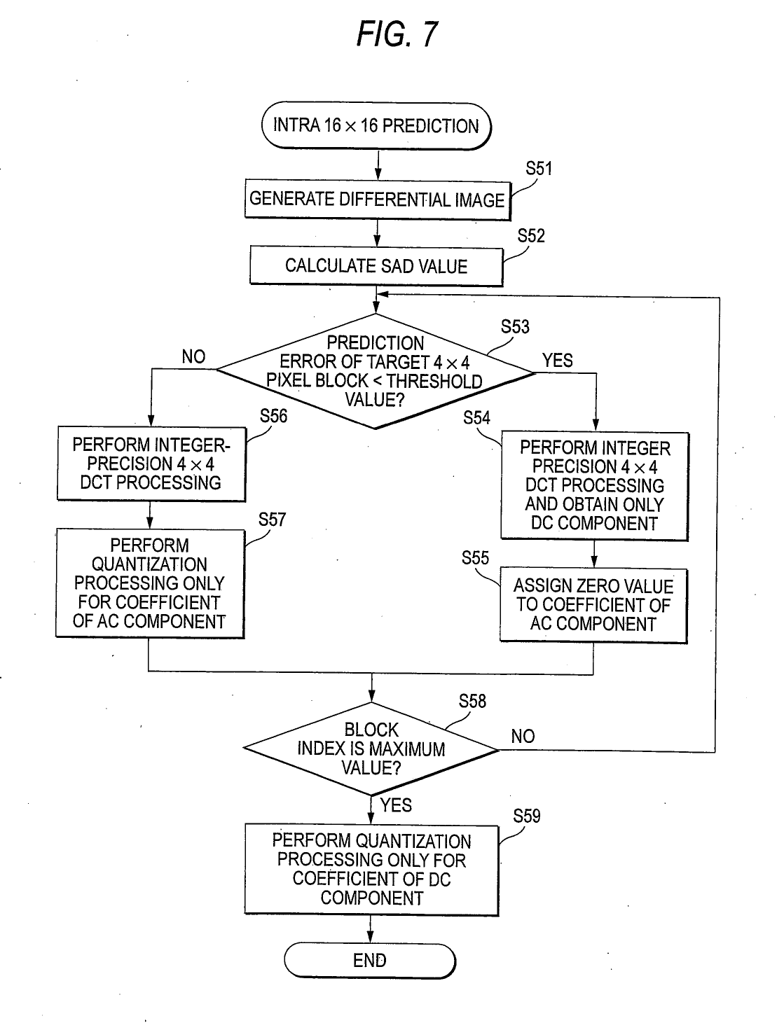

The case where the control section 14 recognizes that the prediction mode is the intra 16×16 prediction mode will be described with reference to FIG. 7.

If it is recognized that the prediction mode is the intra 16×16 prediction mode, the subtracter 6 receives the intra 16×16 prediction signal output from the intraprediction section 3 through the selection circuit 5 and the signal provided by dividing an input signal and calculates a difference between the signals to generate a differential image under the control of the control section 14 (S51). When the differential image is generated, the control section 14 divides the differential image made up of 16×16 pixels into blocks each made up of 4×4 pixels and also calculates the SAD value indicating a prediction error in 4×4 pixel block units (S52).

Subsequently, the control section 14 reads a predetermined threshold value according to the coding mode and makes a comparison between the threshold value and the SAD value calculated in 4×4 pixel units (S53). If the SAD value is equal to or less than the threshold value, the control section 14 causes the DCT/quantization section 9 to execute DCT for obtaining only DC component (S54) and to assign a zero value to AC component (S55).

The DCT processing for obtaining only DC component is light processing as compared with usual DCT for finding DC component and AC component.

On the other hand, if the prediction error exceeds the threshold value, the control section 14 controls the DCT/quantization section 9 so as to execute integer precision DCT for the differential image made up of 4×4 pixel (S56) and to execute quantization processing only for the AC component obtained in the DCT (S57).

When execution of S55 or S56 and S57 terminates, whether or not the block index of the 4×4 pixel block to be coded is the maximum value is checked (S58). If the block index is not the maximum value, the process returns to S53 and similar processing is executed for the next 4×4 pixel differential image.

If the block index is the maximum value, a DC component block made up of coefficients of DC components of the 4×4 pixel blocks into which the image is previously divided is generated and processing of orthogonal transformation of Hadamard transformation, etc., and quantization is performed for the DC component block (S59).

Upon completion of the processing, the DCT coefficient output from the DCT/quantization section 9 is subjected to variable length coding processing in the entropy coding section 10 and is output.

As described above, the DCT and quantization processing is changed according to the nature of the signal of the coding mode, etc., whereby it is made possible to reduce the processing amount in the DCT and quantization processing while suppressing degradation of the image quality.

The coding mode of the intra 16×16 prediction mode is also characterized by the fact that quantization for the coefficient of the DC component is executed because it has a feature that the coefficient of the DC component easily remains.

### SIXTH EXAMPLE

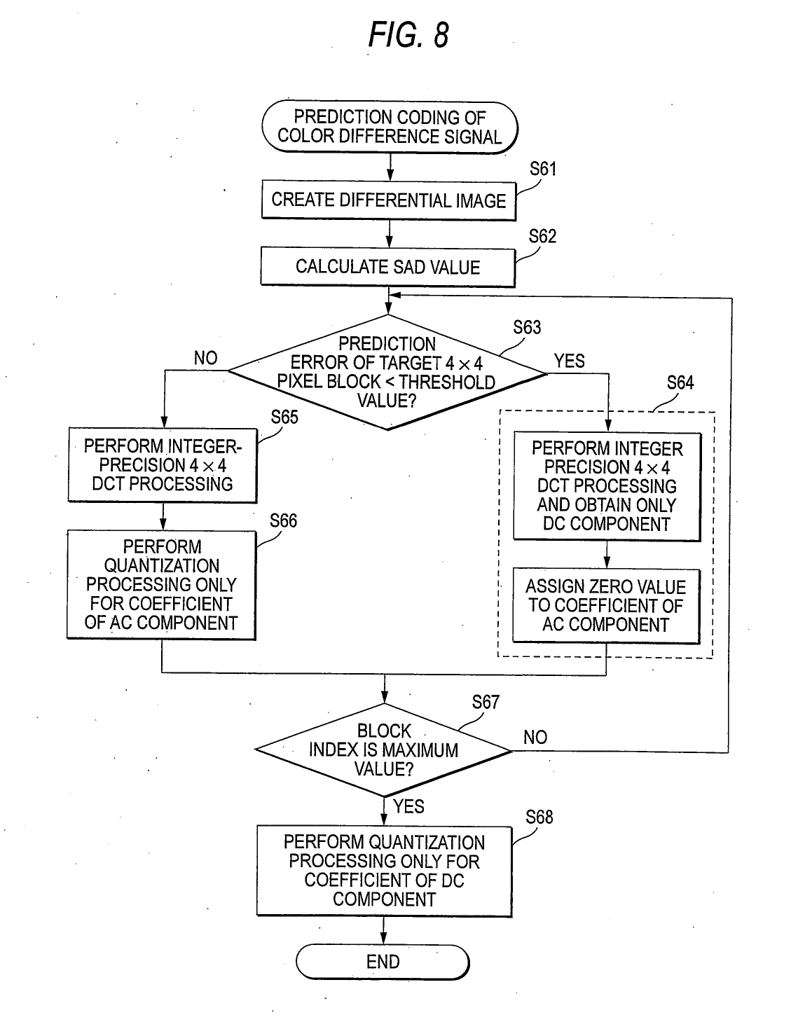

The case where the control section 14 recognizes that coding processing is to be performed for a color difference signal will be described with reference to FIG. 8.

If the control section 14 recognizes that coding processing is to be performed for a color difference signal, the control section 14 controls the interprediction section 2 or the intraprediction section 3 to generate a prediction image of the block to be coded, included in an input signal and controls the subtracter 6 to calculate a difference between the block to be coded and the created prediction image to create a differential image (S61). To code a color difference signal, the coding is executed in 8×8 pixel block units and thus the block to be coded is made up of 8×8 pixel.

When the differential image is generated, the control section 14 calculates the SAD value representing a prediction error for each block made up of 4×4 pixel from the differential image (S62).

Subsequently, the control section 14 reads a predetermined threshold value according to the coding mode and makes a comparison between the threshold value and the SAD value calculated in 4×4 pixel units, namely, prediction error to determine whether or not the prediction error is equal to or less than the threshold value (S63).

If the prediction error is equal to or less than the threshold value as a result of the determination, the control section 14 controls the DCT/quantization section 9 so as to assign a zero value to all DCT coefficients (S64).

On the other hand, if it is determined at S63 that the prediction error exceeds the threshold value, the control section 14 controls the DCT/quantization section 9 so as to execute integer precision DCT processing in block units of 4×4 pixel (S65) and to execute quantization processing for the coefficient obtained in the integer precision DCT processing (S66).

Upon completion of the DCT and quantization processing, the control section 14 checks whether or not the block index of the block subjected to the processing indicates the maximum value (S67). If the block index indicates the maximum value, the control section 14 creates a DC component block made up of the coefficients of DC components of the 4×4 pixel blocks into which the image was previously divided is generated and performs processing of orthogonal transformation of Hadamard transformation, etc., and quantization is performed for the DC component block (S68).

On the other hand, if the block index is not the maximum value, the process returns to S53 and the step of comparison between the prediction error of the next 4×4 pixel block and the threshold value and the later steps are executed.

Upon completion of the processing, the DCT coefficient output from the DCT/quantization section 9 is subjected to variable length coding processing in the entropy coding section 10 and is output.

Thus, the DCT and quantization processing is changed according to the nature of the signal of the coding mode, etc., whereby it is made possible to reduce the processing amount in the DCT and quantization processing while suppressing degradation of the image quality.

The coding mode of the color difference signal is also characterized by the fact that quantization for the coefficient of the DC component is executed because it has a feature that the coefficient of the DC component easily remains.

In the comparison between the prediction error and the threshold value, determination is made based on “prediction error<threshold value,” but may be made based on “prediction error>threshold value,” “prediction error≦threshold value,” or “prediction error≦threshold value.”

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

What is claimed is:

1. A video coding apparatus for coding a video signal comprising a frame which is divided into a plurality of blocks, the video coding apparatus comprising:
a prediction section that performs a plurality of predictions for each of the plurality of blocks or each of subblocks into which each of the blocks is divided to output a plurality of prediction signals;
a selection section that selects one of the plurality of prediction signals for each of blocks for which the plurality of prediction are performed;
a post-processing section that performs a post-processing for the selected one of the plurality of prediction signals; and
a controller that controls the post-processing section to change the post-processing based on information regarding a prediction by which the selected one of the plurality of prediction signals is obtained.

2. The video coding apparatus according to claim 1,
wherein the post-processing comprises a discrete cosine transform processing and a quantization processing.

3. The video coding apparatus according to claim 2,
wherein the information regarding the prediction includes a characteristic thereof or coding mode information thereof.

4. The video coding apparatus according to claim 3,
wherein the coding mode information indicates prediction block size in the prediction.

5. The video coding apparatus according to claim 1,
wherein the plurality of predictions comprise an interprediction and an intraprediction.

6. A video coding apparatus for coding a video signal comprising a frame which is divided into a plurality of blocks, the video coding apparatus comprising:
a first prediction section that (i) performs a first interprediction for a target block among the plurality of the blocks or (ii) performs a second interprediction for first subblocks into which the target block is divided;
a second prediction section that (i) performs a first intraprediction for the target block and (ii) performs a second intraprediction for second subblocks into which the target block is divided;
a selection section that selects a precise prediction from among the first and second interpredictions and the first and second intrapredictions based on results of the first and second prediction sections;
a subtracter that generates a plurality of differential image subblocks by dividing a differential image between the target block and a prediction image block when the first intraprediction, second intraprediction or second interprediction is selected as the precise prediction, the prediction image block being obtained by the precise prediction selected by the selection section;
an evaluation value calculation section that calculates a prediction error in each of the plurality of differential image subblocks;
a determination section that compares each of the prediction errors and a threshold value;
a post-processing section that performs a discrete cosine transform processing with a DCT processing unit and a quantization processing; and
a controller that controls the post-processing section
(i) to perform the discrete cosine transform processing and the quantization processing for each of the differential image subblocks when the prediction error in the respective differential image subblock is larger than the threshold value, and
(ii) not to perform the discrete cosine transform processing and not to perform the quantization processing and to assign zero to all discrete cosine transform coefficients for each of the differential image subblocks when the prediction error in the respective differential image subblock is not larger than the threshold value.

7. The video coding apparatus according to claim 6,
wherein the first and second interpredictions are performed by using correlation in time domain, and
wherein the first and second intrapredictions are performed by using correlation in space domain.

8. The video coding apparatus according to claim 6,
wherein the threshold value is determined according to the selected precise prediction.

9. The video coding apparatus according to claim 8, further comprising a storage section that stores a plurality of threshold values,
wherein the threshold value is selected from among the plurality of threshold values according to the selected precise prediction.

10. The video coding apparatus according to claim 6,
wherein the controller controls the post-processing section according to the DCT processing unit of the discrete cosine transform processing.

11. A video coding apparatus for coding a video signal comprising a frame which is divided into a plurality of blocks, the video coding apparatus comprising:
a first prediction section that (i) performs a first interprediction for a target block among the plurality of the blocks or (ii) performs a second interprediction for first subblocks into which the target block is divided;
a second prediction section that (i) performs a first intraprediction for the target block and (ii) performs a second intraprediction for second subblocks into which the target block is divided;
a selection section that selects a precise prediction from among the first and second interpredictions and the first and second intrapredictions based on results of the first and second prediction sections;
a subtracter that generates a plurality of differential image subblocks smaller than the second subblocks by dividing a differential image block between the target block and a prediction image block when the third interprediction is selected as the precise prediction, the prediction image being obtained by the precise prediction selected by the selection section;
an evaluation value calculation section that calculates a prediction error in each of the plurality of differential image subblocks;
a determination section that compares each of the prediction errors and a threshold value;
a post-processing section that performs a discrete cosine transform processing with a DCT processing unit and a quantization processing; and
a controller that controls the post-processing section
(i) to perform the discrete cosine transform processing for each of the differential image subblocks and to perform quantization processing only for obtained coefficients of AC component for each of the differential image subblocks when the prediction error in the respective differential image subblock is larger than the threshold value,
(ii) to perform a discrete cosine transform processing only for obtaining coefficients of DC component, to assign zero to coefficients of AC component for each of the differential image subblocks when the prediction error in the respective differential image subblock is not larger than the threshold value, and
(iii) to generate DC blocks based on the obtained coefficients of DC component, to perform orthogonal transformation and a quantization processing for the generated DC blocks.

12. The video coding apparatus according to claim 11,
wherein the first and second interpredictions are performed by using correlation in time domain, and
wherein the first and second intrapredictions are performed by using correlation in space domain.

13. The video coding apparatus according to claim 11,
wherein the threshold value is determined according to the selected precise prediction.

14. The video coding apparatus according to claim 13, further comprising a storage section that stores a plurality of threshold values,
wherein the threshold value is selected from among the plurality of threshold values according to the selected precise prediction.

15. The video coding apparatus according to claim 11,
wherein the controller controls the post-processing section according to the DCT processing unit of the discrete cosine transform processing.
